(19) United States
(12) Patent Application Publication
(10) Pub. No.: US 2022/0108193 A1
(43) Pub. Date: Apr. 7, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Masahiro SATO, Kanagawa (JP); Sho TAKEMORI, Kanagawa (JP)

(73) Assignee: FUJIFILM Business Innovation Corp., Tokyo (JP)

(21) Appl. No.: 17/324,298

(22) Filed: May 19, 2021

(30) Foreign Application Priority Data
Oct. 5, 2020 (JP) 2020-168762

(51) Int. Cl. G06N 5/04; G06N 20/00

(52) U.S. Cl. CPC G06N 5/04; G06N 20/00

(57) ABSTRACT

An information processing apparatus includes: a processor configured to: calculate, for each of plural objects, a recommendation effect that is a degree of influence of recommendation of the object on a user selecting the object, based on a recommendation history indicating an object that was recommended to the user among the plural objects, a non-recommendation history indicating an object that was not recommended, and an action history indicating the object that was selected by the user among the plural objects; and probabilistically determine an object to be recommended according to the recommendation effects calculated for the respective objects.

### CROSS-REFERENCE TO RELATED APPLICATIONS

This application is based on and claims priority under 35 USC 119 from Japanese Patent Application No. 2020-168762 filed Oct. 5, 2020.

### BACKGROUND

### (i) Technical Field

The present disclosure relates to an information processing apparatus and a non-transitory computer readable medium.

### (ii) Related Art

JP-A-2020-9283 discloses a selection system. The selection system includes: an acquisition unit configured to acquire probability information on a probability of each of plural options in which a probability of obtaining a predetermined event changes as time elapses; a selection unit configured to select an option according to a predetermined criterion based on the probability information of each of the options, the selection unit being configured to select not only the option but also an option not selected according to the predetermined criterion; and an update unit configured to update the probability information based on an event obtained by each of the options selected by the selection unit.

JP-A-2017-211699 discloses a program. The program causes a computer to implement a function of extracting, from plural consumers, a consumer whose degree of influence due to recommendation when a specific product is recommended satisfies a predetermined condition, and a function of recommending the specific product to the extracted consumer.

JP-A-2020-047156 discloses a product recommending apparatus. The product recommending apparatus includes: an acquisition unit configured to obtain a purchase history indicating information on a product purchased by a user and a promotion history indicating information on a product promoted to the user; a classification unit configured to classify, using the purchase history and the promotion history, each product into one of a first group of products purchased but not promoted, a second group of products purchased and promoted, a third group of products not purchased or promoted, and a fourth group of products not purchased but promoted; and a controller configured to output, using a result of classification obtained by the classification unit, a product that would not be purchased if not promoted and would be purchased if promoted as a product to be recommended to the user.

### SUMMARY

As a search method for selecting an optimal option from various options and maximizing a reward, there is a bandit algorithm. The bandit algorithm is applied to, for example, marketing for selling objects such as products. The system with the bandit algorithm recommends not only an object that would be selected according to a predetermined criterion but also an object that would not be selected according to the predetermined criterion. In this system, objects that are not normally recommended are also recommended. However, objects that are not recommended are not considered. That is, an effect due to presence or absence of recommendation is not considered.

Aspects of non-limiting embodiments of the present disclosure relate to providing an information processing apparatus and a non-transitory computer readable medium that can explore a recommendation effect and maximize the recommendation effect.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a processor configured to: calculate, for each of plural objects, a recommendation effect that is a degree of influence of recommendation of the object on a user selecting the object, based on a recommendation history indicating an object that was recommended to the user among the plural objects, a non-recommendation history indicating an object that was not recommended, and an action history indicating the object that was selected by the user among the plural objects; and probabilistically determine an object to be recommended according to the recommendation effects calculated for the respective objects.

### BRIEF DESCRIPTION OF THE DRAWINGS

Exemplary embodiment(s) of the present disclosure will be described in detail based on the following figures, wherein:

FIG. 1 is a diagram showing an example of an overall configuration of an information processing system according to first and second exemplary embodiments;

FIG. 2 is a block diagram showing a schematic configuration of an information processing apparatus according to the first and second exemplary embodiments;

FIG. 3 is a functional block diagram of the information processing apparatus according to the first exemplary embodiment;

FIG. 4 is a diagram showing an example of a recommendation effect and a probability that are obtained based on a recommendation history, a non-recommendation history, and a purchase history;

FIG. 5 is a flowchart showing an example of a specific process by the information processing apparatus according to the first exemplary embodiment;

FIG. 6 is a diagram showing an example of a recommendation effect and a probability that are obtained based on a recommendation history, a non-recommendation history, and a purchase history;

FIG. 7 is a functional block diagram of the information processing apparatus according to the second exemplary embodiment;

FIG. 8 is a diagram showing an example of a recommendation effect and an uncertainty that are obtained based on a recommendation history, a non-recommendation history, and a purchase history;

FIG. 9 is a flowchart showing an example of a specific process performed by the information processing apparatus according to the second exemplary embodiment;

FIG. 10 is a diagram showing an example of a recommendation effect, an uncertainty, and a probability that are obtained based on a recommendation history, a non-recommendation history, and a purchase history; and

FIG. 11 is a diagram showing an example of a recommendation effect, an uncertainty, and a probability that are obtained based on a recommendation history, a non-recommendation history, and a purchase history.

### DETAILED DESCRIPTION

### First Exemplary Embodiment

Hereinafter, an example of the present exemplary embodiment will be described in detail with reference to the drawings.

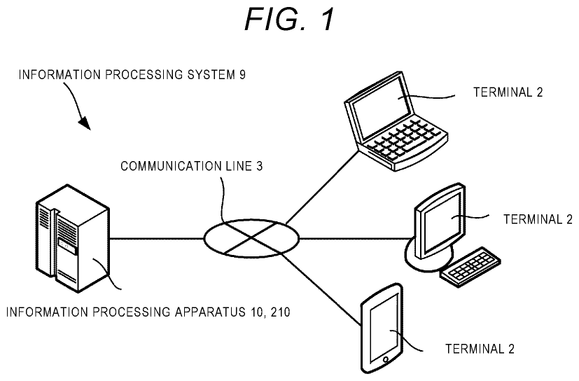

FIG. 1 is a diagram showing an example of an overall configuration of an information processing system 9. The information processing system 9 includes an information processing apparatus 10, terminals 2, and a communication line 3 that communicably connects the information processing apparatus 10 and the terminals 2.

The communication line 3 may be, for example, a local area network (LAN), a wide area network (WAN), the Internet, or a combination thereof.

Each of the terminals 2 is an information processing terminal referred to as a personal computer, a smartphone, a slate PC, a tablet PC, or the like. The terminal 2 exchanges information with, for example, a server device (not shown) connected to the communication line 3. The server device is an information processing apparatus that runs a virtual store on the Internet. The server device transmits data such as images and prices of the products to the terminal 2 in response to an operation of a user of the terminal 2, and receives an instruction to purchase a product from the user.

Further, the server device extracts one or more products from products that are sold on the server device, and transmits images or the like of the products to the terminal 2, thereby advertising the products to the user of the terminal 2.

In this case, the products described above are an example of objects selected by the user. Advertising a product to the user is an example of recommending the product (which is the example of the object) to the user. The purchase of the product by the user is an example in which the user selects the product (which is the example of the object).

The above-described products may be individual products indicated by product names or model numbers, or may be a category of products, for example, milk, fresh food, or stationery.

The information processing apparatus 10 monitors advertisement of products by the server device and the purchase of products by the terminal 2, and stores a history of the advertisement and a history of the purchase. The user browses data such as images and prices of products transmitted from the server device. The data on the products include data recommended and transmitted by the server device regardless of the intention of the user.

When the user performs a purchase operation within a predetermined time after a product is advertised to the user, the information processing apparatus 10 determines that the product is purchased due to the advertisement of the product. When the user does not perform the purchase operation within the predetermined time, the information processing apparatus 10 determines that the product is not purchased due to the advertisement of the product.

The browse and purchase of the product by the terminal 2 may be monitored by an apparatus other than the information processing apparatus 10. The information processing apparatus 10 may simply acquire results of the above-mentioned monitoring.

Each of the number of the information processing apparatus 10, the number of the terminal 2, and the number of the communication line 3 in the information processing system 9 is not limited to that shown in FIG. 1, and may be one or more.

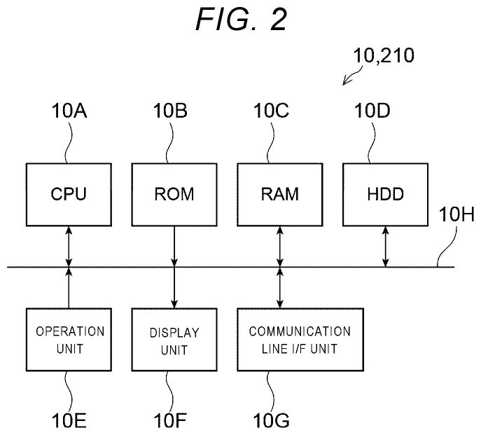

FIG. 2 is a block diagram showing a schematic configuration of the information processing apparatus according to the present exemplary embodiment.

The information processing apparatus 10 according to the present exemplary embodiment includes a central processing unit (CPU) 10A (an example of a processor), a read only memory (ROM) 10B, a random access memory (RAM) 10C, a hard disk drive (HDD) 10D, an operation unit 10E, a display unit 10F, and a communication line interface (I/F) unit 10G. The CPU 10A controls overall operations of the information processing apparatus 10. The ROM 10B stores various control programs, various parameters, and the like in advance. The RAM 10C is used as a work area or the like when the CPU 10A executes various programs. The HDD 10D stores various data, application programs, and the like. The operation unit 10E includes various operation input devices such as a keyboard, a mouse, a touch panel, and a touch pen. The operation unit 10E is used to input various information. A display such as a liquid crystal display is applied to the display unit 10F.

The display unit 10F is used to display various information. The communication line I/F unit 10G is connected to the communication line 3, and transmits various data to and receives various data from other devices connected to the communication line 3. The above-described units of the information processing apparatus 10 are electrically connected by a system bus 10H. In the information processing apparatus 10 according to the present exemplary embodiment, the HDD 10D is applied as a storage unit. The disclosure is not limited thereto. Alternatively, another nonvolatile storage unit such as a flash memory may be applied.

With the above configuration, in the information processing apparatus 10 according to the present exemplary embodiment, the CPU 10A accesses to the ROM 10B, the RAM 10C, and the HDD 10D, acquires various data via the operation unit 10E, and displays various information on the display unit 10F. In the information processing apparatus 10, the CPU 10A controls transmission and reception of communication data via the communication line I/F unit 10G.

In the information processing apparatus 10 according to the present exemplary embodiment, the CPU 10A executes a program stored in advance in the ROM 10B or the HDD 10D to perform a process of determining a product to be recommended to the user.

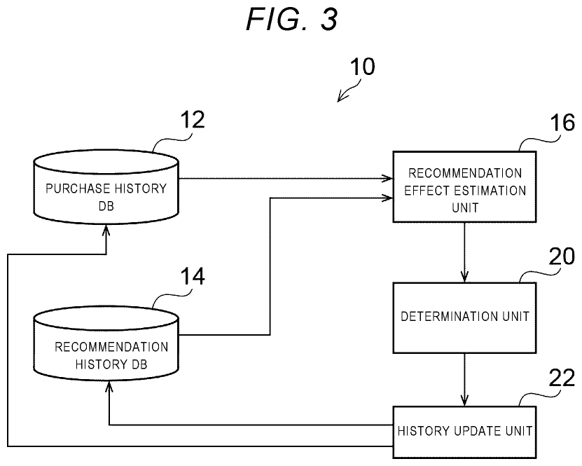

Next, a functional configuration of the information processing apparatus 10 according to the present exemplary embodiment configured as described above will be described. FIG. 3 is a functional block diagram of the information processing apparatus 10 according to the present exemplary embodiment. Each functional unit is implemented by the CPU 10A executing a program stored in advance in the ROM 10B or the HDD 10D.

The information processing apparatus 10 has functions of a purchase history database (DB) 12, a recommendation history database (DB) 14, a recommendation effect estimation unit 16, a determination unit 20, and a history update unit 22.

The purchase history database 12 stores, for each user, a purchase history indicating products purchased by the user among plural products. Specifically, the purchase history database 12 stores, for each user, a purchase history indicating the number of times a product was purchased (which may be referred to as the number of purchases) when the product had been recommended and the number of times a product was purchased when the product had not been recommended on a product basis. Here, it is assumed that one product is selected and advertised every time there is an opportunity to advertise a product to the user. For example, when a product advertisement is also posted on a receipt that is output at the time of accounting for a purchase of a product, a receipt output after accounting is an opportunity to advertise a product. In addition, when a product advertisement pops up at the time of logging in to an EC site, an advertisement opportunity is after each login. Here, the number of purchases when a product had been recommended is the number of times an operation of purchasing the product was performed after the product had been advertised to the user until a next advertisement opportunity. The number of purchases when a product had not been recommended is the number of times an operation of purchasing the product was performed from when another product different from the product had been advertised to the user until a next advertisement opportunity. When there has been no advertisement opportunity and an operation of purchasing a product is performed after a certain period of time has elapsed from a previous advertisement opportunity, the number of purchases is counted as the number of purchases when a product has not been recommended.

The recommendation history database 14 stores, for each user, a recommendation history indicating products being recommended to the user among plural products and a non-recommendation history indicating products being not recommended to the user. Specifically, the recommendation history database 14 stores, for each user, a recommendation history indicating the number of times a product was recommended (which may be referred to as “the number of recommendations”) and the number of times a product was not recommended (which may be referred to as “the number of non-recommendations”) on a product basis.

Here, the number of times a product was recommended (that is, the number of recommendations) is the number of times the product was advertised to the user. The number of times a product was not recommended (that is, the number of non-recommendations) is a sum of the number of times a product(s) different from the product were advertised to the user and the number of times no product was advertised.

The recommendation effect estimation unit 16 estimates, for each product, a recommendation effect based on the recommendation history and the non-recommendation history stored in the recommendation history database 14 and the purchase history stored in the purchase history database 12. The recommendation effect is a degree of influence of recommendation of a product on purchase of the product by the user.

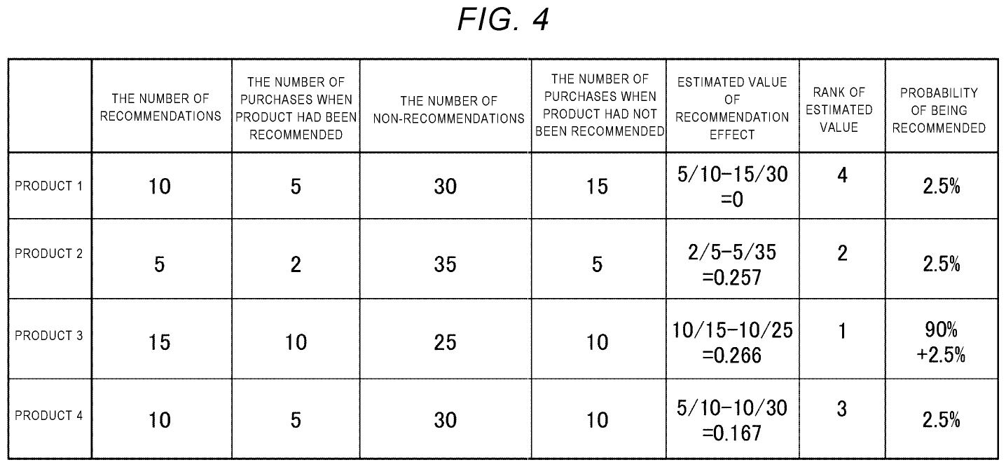

Specifically, the recommendation effect is a difference between a degree to which the user purchased a product when the product had been recommended and a degree to which a user purchased the product when the product had not been recommended. For example, as shown in FIG. 4, for each product, a difference between a purchase rate that is a value obtained by dividing the number of purchases when a product had been recommended by the number of recommendations and a purchase rate that is a value obtained by dividing the number of purchases when a product had not been recommended by the number of non-recommendations is calculated as an estimated value of the recommendation effect. In the example of FIG. 4, for “product 1”, a difference (=0) between a purchase rate (=5/10), which is a value obtained by dividing the number of purchases “5” when the product had been recommended by the number of recommendations “10”, and a purchase rate (=15/30), which is a value obtained by dividing the number of purchases “15” when the product had not been recommended by the number of non-recommendations “30”, is calculated as the estimated value of the recommendation effect.

The determination unit 20 probabilistically determines a product to be recommended according to the recommendation effects calculated for the respective products. For example, as shown in FIG. 4, a probability of a product having the maximum estimated value of the recommendation effect is set to 90%, and a probability obtained by dividing 10% by the number of all products is added to probabilities of all the products. The product to be recommended is determined according to the obtained probabilities of the respective products. In the example of FIG. 4, a probability of “product 3” having a first rank in descending order of estimated values of the recommendation effect is 92.5%. The probability 92.5% is obtained by adding the probability 2.5% obtained by dividing 10% by the number of products “4” to 90%. Then, probabilities of “product 1”, “product 2”, “product 4” having second to fourth ranks in descending order of the estimated values of the recommendation effect are set to 2.5%.

The history update unit 22 advertises the determined product to the user by the server device, observes a product purchased by the user, and updates the recommendation history, the non-recommendation history, and the purchase history of the user.

Specifically, the determined product is advertised to the user via the server device, a product purchased by the user is observed, the number of times the product was recommended in the recommendation history of the user is incremented by 1, and the number of times each of products different from the product was not recommended in the non-recommendation history of the user is incremented by 1.

When the product purchased by the user is an advertised product, the number of purchases when the product had been recommended in the purchase history of the user is incremented by 1.

When the product purchased by the user is a product different from the advertised product, the number of purchases when the purchased product had not been recommended in the purchase history of the user is incremented by 1.

Processes of the recommendation effect estimation unit 16, the determination unit 20, and the history update unit 22 are repeated at each timing at which a product is advertised to a user. The above processes are performed for each user.

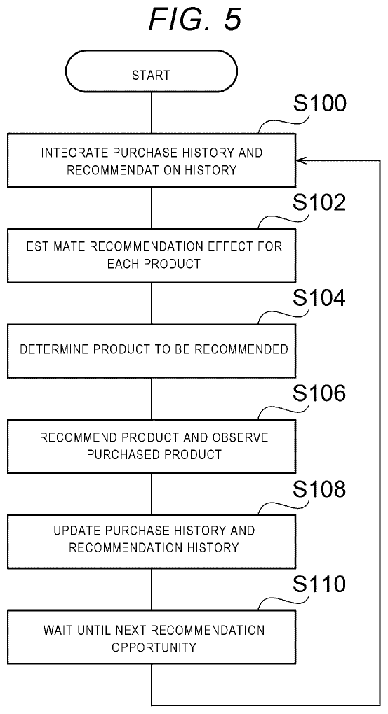

Next, a process performed by the information processing apparatus 10 according to the present exemplary embodiment configured as described above will be described. FIG. 5 is a flowchart showing an example of a specific process performed by the information processing apparatus 10 according to the present exemplary embodiment. The process of FIG. 5 is executed for each user. In addition, the process of FIG. 5 starts when it is time to advertise a product to a user who is a target to be processed.

In step S100, the recommendation effect estimation unit 16 acquires and integrates the recommendation history and the non-recommendation history of the user of interest stored in the recommendation history database 14 and the purchase history of the user of interest stored in the purchase history database 12. Specifically, as shown in FIG. 4, for the user of interest, the recommendation effect estimation unit 16 obtains the number of recommendations, the number of purchases when a product had been recommended, the number of non-recommendations, and the number of purchases when a product had not been recommended, on a product basis.

In step S102, the recommendation effect estimation unit 16 estimates the recommendation effect for the user of interest on a product basis based on the number of recommendations of the product, the number of purchases when the product had been recommended, the number of non-recommendations, and the number of purchases when the product had not been recommended.

In step S104, the determination unit 20 obtains a probability of each product according to the recommendation effect calculated for the product, and determines a product to be recommended according to the obtained probabilities.

In step S106, the history update unit 22 advertises the determined product to the user of the interest by the server device, and observes a product purchased by the user.

In step S108, the history update unit 22 updates the recommendation history, the non-recommendation history, and the purchase history of the user of interest based on the product determined in step S104 and an observation result in step S106.

In step S110, the information processing apparatus 10 waits until a next recommendation opportunity for the user of interest, and returns to step S100 when the next recommendation opportunity comes.

By repeatedly performing the estimation of the recommendation effect, the determination of a product to be recommended, the advertisement of the product, the observation, and the update of the history described above, it is possible to search for the recommendation effect and maximize the recommendation effect in a long term.

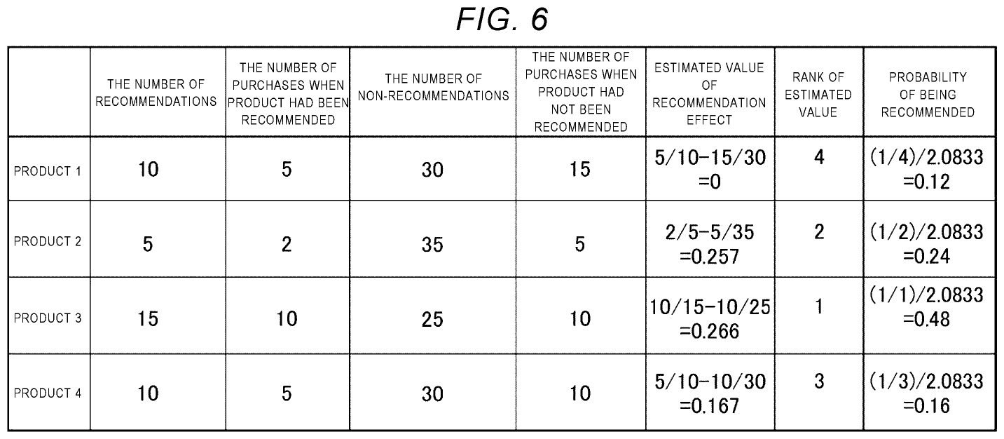

The first exemplary embodiment has described an example in which a product having the maximum estimated value of the recommendation effect is recommended with a probability of 90% and all products are randomly recommended with a probability of 10%. The disclosure is not limited thereto. For example, as shown in FIG. 6, a product having a higher rank in descending order of estimated values of the recommendation effect may be recommended with a higher probability. In the example of FIG. 6, a probability proportional to a reciprocal number of a rank in descending order of the recommendation effect is calculated as a probability with which a product is recommended (which will be referred to as a “probability of being recommended”). Specifically, (1/4)/2.0833=0.12 is calculated for the product 1. For the product 2, (1/2)/2.0833=0.24 is calculated as the probability of being recommended. For the product 3, (1/1)/2.0833=0.48 is calculated as the probability of being recommended. For the product 4, (1/3)/2.0833=0.16 is calculated as the probability of being recommended. It is noted that 1/1+1/2+1/3+1/4=2.0833, and that a sum of the probabilities is normalized to 1 by dividing the respective probabilities by this value.

### Second Exemplary Embodiment

Next, a second exemplary embodiment will be described. Parts having the same configurations as those in the first exemplary embodiment are denoted by the same reference numerals, and the description thereof is omitted.

An information processing apparatus 210 according to the present exemplary embodiment has the same schematic configuration as that of the information processing apparatus 10 of FIG. 1.

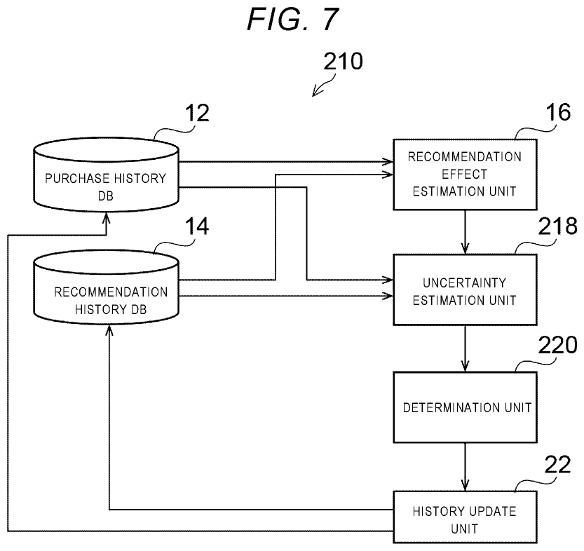

A functional configuration of the information processing apparatus 210 according to the present exemplary embodiment will be described. FIG. 7 is a functional block diagram of the information processing apparatus 210 according to the present exemplary embodiment. Each functional unit is implemented by the CPU 10A executing a program stored in advance in the ROM 10B or the HDD 10D.

The information processing apparatus 210 has functions of the purchase history database 12, the recommendation history database 14, the recommendation effect estimation unit 16, an uncertainty estimation unit 218, the determination unit 220, and the history update unit 22.

The uncertainty estimation unit 218 calculates, for each user, an uncertainty of the recommendation effect of the user on a product basis based on the recommendation history and the non-recommendation history stored in the recommendation history database 14.

Specifically, the uncertainty estimation unit 218 calculates the uncertainty of the recommendation effect of each product so that the uncertainty increases as the smaller one of the number of recommendations and that of non-recommendation decreases.

The uncertainty estimation unit 218 calculates the uncertainty of the recommendation effect according to, for example, the following equation.

$$\frac{\sqrt{\begin{matrix}log ( the number of recommendations + \\ the number of non \text{-} recommendations\end{matrix}}}{\sqrt{\begin{matrix}2 \times ( smaller one of the number of recommendations and \\ the number of non \text{-} recommendations )\end{matrix}}}$$

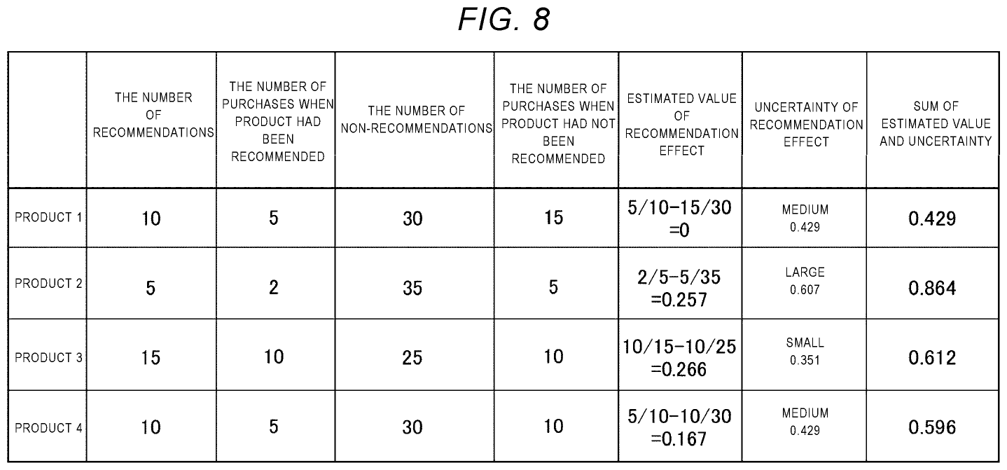

In the example of FIG. 8,

$$\frac{\sqrt{log ( 10 + 30 )}}{\sqrt{2 \times 10}} = 0.429$$

is calculated as the uncertainty of the recommendation effect for the product 1.

The determination unit 220 determines a product to be recommended according to the recommendation effects and the uncertainties calculated for the respective products so that a product having a higher recommendation effect and a higher uncertainty is more likely to be recommended. Specifically, the determination unit 220 sets a probability of recommending a product having a maximum sum of the recommendation effect and the uncertainty calculated on a product basis to 1, sets a probability of recommending other products to 0, and determines a product to be recommended.

For example, as shown in FIG. 8, for the product 1, the sum of the recommendation effect and the uncertainty is 0+0.429=0.429. For the product 2, the sum of the recommendation effect and the uncertainty is 0.257+0.607=0.864. For the product 3, the sum of the recommendation effect and the uncertainty is 0.266+0.351=0.612. For the product 4, the sum of the recommendation effect and the uncertainty is 0.167+0.429=0.596. Therefore, the product 2 having the maximum sum of the recommendation effect and the uncertainty is determined as the product to be recommended.

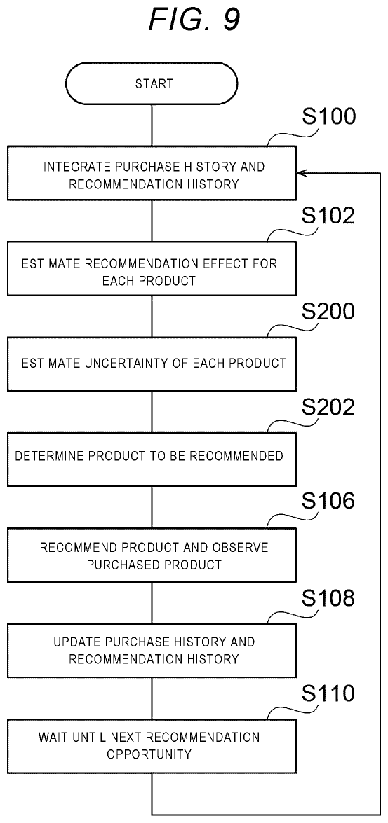

Next, a process performed by the information processing apparatus 210 according to the present exemplary embodiment configured as described above will be described. FIG. 9 is a flowchart showing an example of a specific process performed by the information processing apparatus 210 according to the present exemplary embodiment. The same processes as those in FIG. 5 are denoted by the same reference numerals, and a detailed description thereof will be omitted.

In step S100, the recommendation effect estimation unit 16 acquires and integrates the recommendation history and the non-recommendation history of a user of interest stored in the recommendation history database 14 and the purchase history of the user of interest stored in the purchase history database 12.

In step S102, the recommendation effect estimation unit 16 estimates the recommendation effect for the user of interest on a product basis based on the number of recommendations of the product, the number of purchases when the product had been recommended, the number of non-recommendations, and the number of purchases when the product had not been recommended.

In step S200, the uncertainty estimation unit 218 calculates, for the user of interest, the uncertainty of the recommendation effect on a product basis based on the recommendation history and the non-recommendation history stored in the recommendation history database 14.

In step S202, the determination unit 220 determines a product having the maximum sum of the recommendation effect and the uncertainty calculated on a product basis as the product to be recommended.

In step S106, the history update unit 22 advertises the determined product to the user of the interest by the server device, and observes a product purchased by the user.

In step S108, the history update unit 22 updates the recommendation history, the non-recommendation history, and the purchase history of the user of interest based on the product determined in step S104 and an observation result in step S106.

In step S110, the information processing apparatus 10 waits until a next recommendation opportunity for the user of interest, and returns to step S100 when the next recommendation opportunity comes.

By repeatedly performing the estimation of the recommendation effect, the determination of a product to be recommended, the advertisement of the product, the observation, and the update of the history described above, it is possible to search for the recommendation effect and maximize the recommendation effect in a long term. By determining the product to be recommended in further consideration of the uncertainty of the recommendation effect, the recommendation effect can be searched for more efficiently.

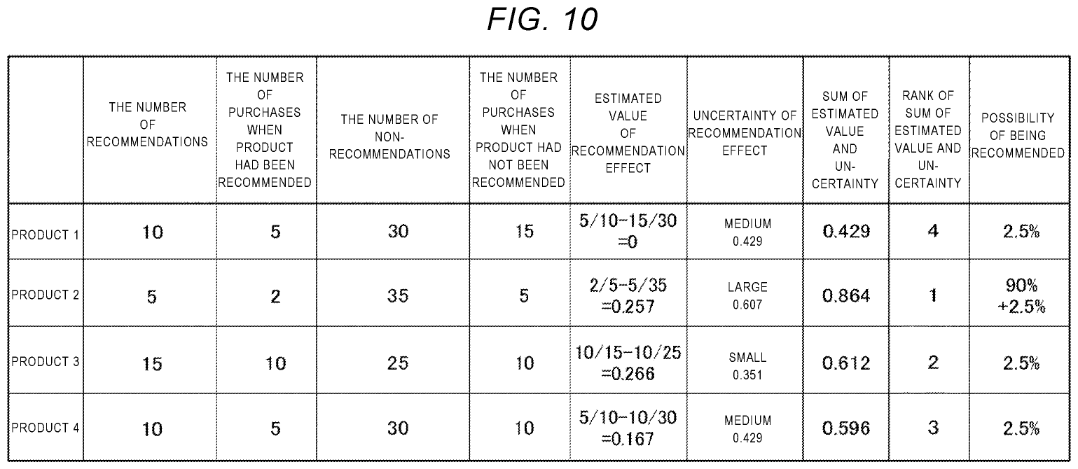

The second exemplary embodiment has described the example in which a product having the maximum estimated value of the recommendation effect is recommended with a probability of 100%. It is noted that the disclosure is not limited thereto. For example, as shown in FIG. 10, a probability of “product 2” having a first rank in descending order of a sum of the estimated value of the recommendation effect and the uncertainty may be set to 92.5%. The probability 92.5% is obtained by adding a probability of 2.5% obtained by dividing 10% by the number of products “4” to 90%. Then, probabilities of “product 1”, “product 3”, and “product 4” having second to fourth ranks in descending order of the sum of the estimated value of the recommendation effect and the uncertainty are set to 2.5%.

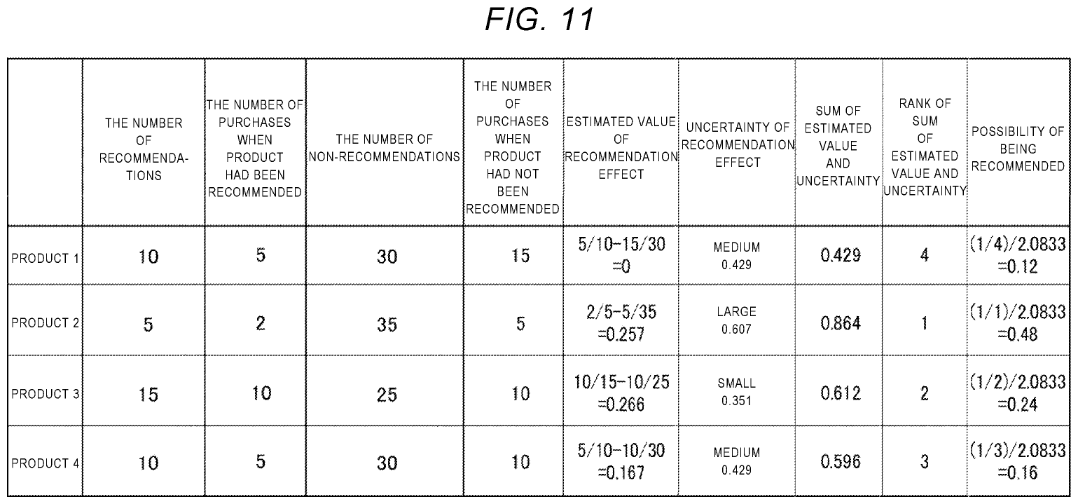

Further alternatively, as shown in FIG. 11, a product having a higher rank in descending order of the sum of the estimated value of the recommendation effect and the uncertainty may be recommended with a higher probability. In the example of FIG. 11, a probability proportional to a reciprocal number of a rank in the descending order of the sum of the estimated value of the recommendation effect and the uncertainty is calculated as the probability of being recommended. For the product 1, (1/4)/2.0833=0.12 is calculated as the probability of being recommended. For the product 2, (1/1)/2.0833=0.48 is calculated as the probability of being recommended. For the product 3, (1/2)/2.0833=0.24 is calculated as the probability of being recommended. For the product 4, (1/3)/2.0833=0.16 is calculated as the probability of being recommended. It is noted that 1/1+1/2+1/3+1/4=2.0833.

The description has been made on the example in which the difference between the purchase rate that is a value obtained by dividing the number of purchases when a product had been recommended by the number of recommendations and the purchase rate that is a value obtained by dividing the number of purchases when a product had not been recommended by the number of non-recommendations is calculated as the recommendation effect. It is noted that the disclosure is not limited thereto. For example, the recommendation effect may be calculated in further consideration of a recommendation type when a product was recommended to the user. Here, the recommendation type is a scale, a method, or the like with which the product was recommended.

For example, when the product was advertised using 20% of a display screen of the terminal 2, the information processing apparatus may calculate the recommendation effect with increasing a weight coefficient as compared to a case where the product was advertised using 10% of the display screen. Specifically, when the information processing apparatuses 10, 210 count the number of recommendations and the number of non-recommendations, the information processing apparatuses 10, 210 may add the weight coefficient instead of incrementing the number of recommendations and the number of non-recommendations by 1. When the information processing apparatuses 10, 210 discount and advertise a product, the information processing apparatuses 10, 210 may determine the weight coefficient according to a discount rate of the product.

The information processing apparatuses 10, 210 may determine the weight coefficient for the product in accordance with, for example, the number of times of advertisements per day, the number of products that were advertised at the same time, and time spending on paying attention to the advertisement when advertising by a video or sound.

The information processing apparatuses 10, 210 may determine different weight coefficients depending on distinctions as to whether the advertisement included only characters, whether the advertisement included a performance that changes as time elapsed, such as blinking or animation, or whether the advertisement included an image or a video.

When calculating the sum of the estimated value of the recommendation effect and the uncertainty, the information processing apparatuses 10, 210 may calculate a weighted sum of the estimated value of the recommendation effect and the uncertainty.

In the above-described exemplary embodiments, a product is an example of an object, advertising a product (advertisement) is an example of recommending an object, and purchasing a product is an example of selecting an object. Examples of an object, recommending an object, and selecting an object are not limited thereto. For example, the selecting of the object described above may include an action of putting a product into a cart or an action of registering a product in a wish list. The phrase “putting a product into a cart” refers to storing a product that a user will purchase in a virtual store in association with identification information of the user, and the phrase “registering a product in a wish list” refers to storing a product of interest as a product that the user wants to obtain as a present or the like.

For example, the information processing apparatuses 10, 210 may recommend another user as a friend to a user of a social networking service (SNS). In this case, the “other user” recommended by the information processing apparatuses 10, 210 is an example of the object described above. The user may register the other user recommended by the information processing apparatuses 10, 210 as a friend. This is an example of the selecting of the object described above.

For example, the information processing apparatuses 10, 210 may recommend a uniform resource identifier (URI) or the like indicating a storage location of an article published on a news site to a user as the object described above. In this case, the user may click the recommended URI to browse the article indicated by the URI or register the URI in a bookmark. These are examples of the selecting of the object described above.

In the exemplary embodiments above, the CPU 10A has been described as an example of a processor. It is noted that the term “processor” refers to hardware in a broad sense. Examples of the processor include general processors (for example, CPU: Central Processing Unit) and dedicated processors (for example, GPU: Graphics Processing Unit, ASIC: Application Specific Integrated Circuit, FPGA: Field Programmable Gate Array, and programmable logic device).

In the embodiments above, the CPU 10A has been described as an example of a processor. It is noted that the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The processing performed by the information processing apparatuses 10, 210 according to the exemplary embodiments described above may be processing performed by software, processing performed by hardware, or a combination of both. The processing performed by the information processing apparatuses 10, 210 may be stored in a storage medium as a program and be distributed.

Further, the present disclosure is not limited to the above exemplary embodiments, and it is needless to say that various modifications other than the above exemplary embodiments can be implemented within a range not departing from the scope of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
calculate, for each of a plurality of objects, a recommendation effect that is a degree of influence of recommendation of the object on a user selecting the object, based on a recommendation history indicating an object that was recommended to the user among the plurality of objects, a non-recommendation history indicating an object that was not recommended, and an action history indicating the object that was selected by the user among the plurality of objects; and
probabilistically determine an object to be recommended according to the recommendation effects calculated for the respective objects.

2. The information processing apparatus according to claim 1, wherein
the processor is configured to:
recommend the determined object to the user;
observe an object selected by the user to update the recommendation history, the non-recommendation history, and the action history; and
repeat the calculating of the recommendation effect, the determining of the object to be recommended, and the updating of the recommendation history, the non-recommendation history, and the action history.

3. The information processing apparatus according to claim 1, wherein
the processor is configured to, when determining the object to be recommended, determine the object to be recommended in accordance with probabilities that are obtained using ranks of the objects in descending order of the recommendation effects calculated for the respective objects.

4. The information processing apparatus according to claim 2, wherein
the processor is configured to, when determining the object to be recommended, determine the object to be recommended in accordance with probabilities that are obtained using ranks of the objects in descending order of the recommendation effects calculated for the respective objects.

5. The information processing apparatus according to claim 1, wherein
the recommendation effect calculated for each object is a difference between a degree to which the user selected the object when the object had been recommended and a degree to which the user selected the object when the object had not been recommended.

6. The information processing apparatus according to claim 2, wherein
the recommendation effect calculated for each object is a difference between a degree to which the user selected the object when the object had been recommended and a degree to which the user selected the object when the object had not been recommended.

7. The information processing apparatus according to claim 3, wherein
the recommendation effect calculated for each object is a difference between a degree to which the user selected the object when the object had been recommended and a degree to which the user selected the object when the object had not been recommended.

8. The information processing apparatus according to claim 4, wherein
the recommendation effect calculated for each object is a difference between a degree to which the user selected the object when the object had been recommended and a degree to which the user selected the object when the object had not been recommended.

9. The information processing apparatus according to claim 1, wherein
the processor is configured to, when determining the object to be recommended, probabilistically determine the object to be recommended in accordance with the recommendation effects calculated for the respective objects and uncertainties of the recommendation effects calculated for the respective objects.

10. The information processing apparatus according to claim 2, wherein
the processor is configured to, when determining the object to be recommended, probabilistically determine the object to be recommended in accordance with the recommendation effects calculated for the respective objects and uncertainties of the recommendation effects calculated for the respective objects.

11. The information processing apparatus according to claim 3, wherein
the processor is configured to, when determining the object to be recommended, probabilistically determine the object to be recommended in accordance with the recommendation effects calculated for the respective objects and uncertainties of the recommendation effects calculated for the respective objects.

12. The information processing apparatus according to claim 4, wherein
the processor is configured to, when determining the object to be recommended, probabilistically determine the object to be recommended in accordance with the recommendation effects calculated for the respective objects and uncertainties of the recommendation effects calculated for the respective objects.

13. The information processing apparatus according to claim 5, wherein
the processor is configured to, when determining the object to be recommended, probabilistically determine the object to be recommended in accordance with the recommendation effects calculated for the respective objects and uncertainties of the recommendation effects calculated for the respective objects.

14. The information processing apparatus according to claim 6, wherein
the processor is configured to, when determining the object to be recommended, probabilistically determine the object to be recommended in accordance with the recommendation effects calculated for the respective objects and uncertainties of the recommendation effects calculated for the respective objects.

15. The information processing apparatus according to claim 7, wherein
the processor is configured to, when determining the object to be recommended, probabilistically determine the object to be recommended in accordance with the recommendation effects calculated for the respective objects and uncertainties of the recommendation effects calculated for the respective objects.

16. The information processing apparatus according to claim 8, wherein
the processor is configured to, when determining the object to be recommended, probabilistically determine the object to be recommended in accordance with the recommendation effects calculated for the respective objects and uncertainties of the recommendation effects calculated for the respective objects.

17. The information processing apparatus according to claim 9, wherein
the processor is configured to, when calculating the uncertainties for the respective objects based on the recommendation history and the non-recommendation history and determining the object to be recommended, probabilistically determine the object to be recommended in accordance with the recommendation effects calculated for the respective objects and the uncertainties calculated for the respective objects so that an object having a higher recommendation effect and a higher uncertainty is more likely to be recommended.

18. The information processing apparatus according to claim 17, wherein
the processor is configured to, when determining the object to be recommended, probabilistically determine the object to be recommended in accordance with sums of (i) the recommendation effects calculated for the respective objects and (ii) the uncertainties of the recommendation effects calculated for the respective objects.

19. The information processing apparatus according to claim 9, wherein
the processor is configured to, when calculating the uncertainties, calculate the uncertainty for each object so that the uncertainty of the recommendation effect increases as a smaller one of the number of times the object was recommended and the number of times the object was not recommended increase.

20. A non-transitory computer readable medium storing a program that cases a computer to execute information processing, the information processing comprising:
calculating, for each of a plurality of objects, a recommendation effect that is a degree of influence of recommendation of the object on a user selecting the object, based on a recommendation history indicating an object that was recommended to the user among the plurality of objects, a non-recommendation history indicating an object that was not recommended, and an action history indicating the object that was selected by the user among the plurality of objects; and
probabilistically determining an object to be recommended according to the recommendation effects calculated for the respective objects.
